(19) United States
(12) Patent Application Publication
(10) Pub. No.: US 2026/0070527 A1
(43) Pub. Date: Mar. 12, 2026

(54) BRAKE SYSTEM

(71) Applicant: UD Trucks Corporation, Ageo-shi (JP)

(72) Inventors: Aurelien CASTELLINI, Ageo-shi (JP); Hiroo YAMAZAKI, Ageo-shi (JP); Katsuya YASHIRO, Ageo-shi (JP); Isamu KUROKAWA, Ageo-shi (JP)

(73) Assignee: UD Trucks Corporation, Ageo-shi (JP)

(21) Appl. No.: 19/324,173

(22) Filed: Sep. 10, 2025

(30) Foreign Application Priority Data
Sep. 11, 2024 (JP) 2024-157578

(51) Int. Cl. B60T 8/1755; B60T 8/34; B60T 8/58

(52) U.S. Cl. CPC B60T 8/17552; B60T 8/34; B60T 8/58; B60T 2230/02; B60T 2250/03; B60T 2250/04

(57) ABSTRACT

Provided is a brake system capable of improving the running stability during parking brake application, the brake system including: a service brake capable of generating a first braking force on a vehicle; and a parking brake capable of generating a second braking force on the vehicle. The brake system includes a hardware processor that controls the first braking force according to the vehicle speed of the vehicle and controls the second braking force according to the vehicle speed.

### RELATED APPLICATION(S)

This application claims the benefit of priority of Japanese Patent Application No. 2024-157578 filed on Sep. 11, 2024, the contents of which are incorporated by reference as if fully set forth herein in their entirety.

### TECHNICAL FIELD

The present disclosure relates to a brake system.

### BACKGROUND ART

A vehicle is equipped with a service brake used for decelerating and stopping the vehicle and a parking brake used for parking. In general, the service brake applies fluid pressure (e.g., air pressure) when being used. The parking brake releases the fluid pressure to apply the force of a spring or the like when being used. Note that, in the following description, the service brake is sometimes referred to as a “main brake” or “foot brake.” Furthermore, a vehicle is equipped with an antilock brake system (ABS), which

automatically repeats application and release of the brakes when the wheels are locked during emergency braking, even if the brake pedal is kept depressed. This helps restore tire grip and maintain vehicle stability.

For example, Patent Literature (hereinafter, referred to as PTL) 1 discloses a brake system including an electric parking brake, in which, in a case where the service brake fails or deteriorates, the electric parking brake is operated as a substitute for the service brake to supply a braking torque to a wheel.

Furthermore, for example, PTL 2 discloses a brake system in which, in a case where an electronic malfunction occurs in a service brake, braking requested by a driver can also be performed using a parking brake.

### CITATION LIST

### Patent Literature

### PTL 1

Japanese Patent Application Laid-Open No. 2016-68940

### PTL 2

German Patent Application Publication No. 102014006615

### SUMMARY OF INVENTION

### Technical Problem

Incidentally, in the brake system disclosed in PTL 1, since the system is not for decelerating and stopping the vehicle according to the vehicle speed, in a case where a failure or the like occurs in the service brake, the wheels are possibly locked when the parking brake is operated to decelerate and stop the vehicle, whereby a problem arises in that the running stability during the parking brake application deteriorates.

Similarly, in the brake system disclosed in PTL 2, since the system is not for decelerating and stopping the vehicle according to the vehicle speed, the wheels are possibly locked when the braking is performed using the parking brake, whereby a problem arises in that the running stability during the parking brake application deteriorates.

An object of the present disclosure is to provide a brake system capable of improving the running stability during parking brake application.

### Solution to Problem

To achieve the above object, a brake system according to the present disclosure is a brake system including a service brake capable of generating a first braking force on a vehicle and a parking brake capable of generating a second braking force on the vehicle, and the brake system includes a hardware processor that controls the first braking force according to the vehicle speed of the vehicle and controls the second braking force according to the vehicle speed.

### Advantageous Effects of Invention

According to the present disclosure, the running stability during parking brake application can be improved.

### BRIEF DESCRIPTION OF DRAWINGS

FIG. 1 is a diagram illustrating a relationship between longitudinal slip and longitudinal friction coefficient;

FIG. 2 is a diagram illustrating a relationship between longitudinal slip and lateral friction coefficient;

FIG. 3 is a block diagram functionally illustrating an example of a brake system according to an embodiment of the present disclosure;

FIG. 4A is a diagram schematically illustrating an example of the brake system during traveling according to the embodiment of the present disclosure;

FIG. 4B is a diagram schematically illustrating an example of the brake system when a service brake is operated according to the embodiment of the present disclosure;

FIG. 4C is a diagram schematically illustrating an example of the brake system when a parking brake is operated according to the embodiment of the present disclosure;

FIG. 5 is a block line diagram illustrating an example of an FF control apparatus according to the embodiment of the present disclosure;

FIG. 6 is a diagram schematically illustrating an example of the parking brake according to the embodiment of the present disclosure; and

FIG. 7 is a block diagram functionally illustrating a variation of the brake system according to the present embodiment.

### DESCRIPTION OF EMBODIMENTS

Hereinafter, an embodiment of the present disclosure will be described with reference to the drawings.

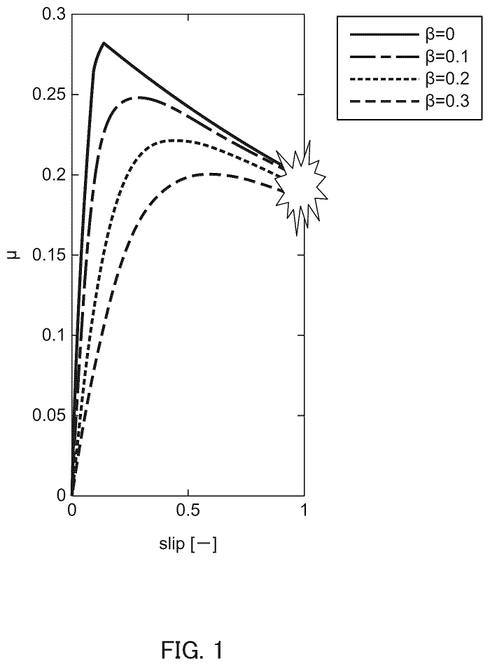

FIG. 1 is a diagram illustrating a relationship between longitudinal slip and longitudinal braking friction coefficient at each of a plurality of lateral slip angles. A vertical axis of FIG. 1 represents a braking friction coefficient μ of a tire (wheel), and a horizontal axis represents a slip rate (percentage (%) obtained by dividing the difference between the vehicle speed and the wheel speed by the vehicle speed). The lateral slip angle is an angle between a direction in which the tire faces and a direction in which the tire travels. In FIG. 1, a relationship between the longitudinal slip and the longitudinal braking friction coefficient at the lateral slip angle β (═O) is shown by a solid line, the relationship at the lateral slip angle β (=0.1) is shown by a one-dot chain line, the relationship at the lateral slip angle β (=0.2) is shown by a dotted line, and the relationship at the lateral slip angle β (=0.3) is shown by a broken line.

As illustrated in FIG. 1, at each of the plurality of lateral slip angles β, a longitudinal grip force of the tire is maximized when the tire slightly slips in the longitudinal direction (when the slip rate is between 10% and 20%), and the grip force is maintained at a high level for a considerable amount of time even when the tire further slips.

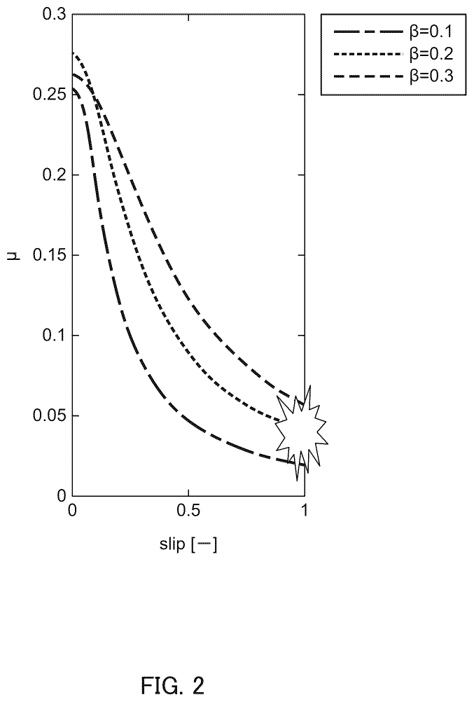

FIG. 2 is a diagram illustrating a relationship between longitudinal slip and lateral braking friction coefficient at each of a plurality of lateral slip angles. A vertical axis of FIG. 2 represents a braking friction coefficient μ of the tire in the lateral direction, and a horizontal axis represents a slip rate (%). In addition, in FIG. 2, a relationship between the longitudinal slip and the lateral braking friction coefficient at the lateral slip angle β (=0.1) is shown by a one-dot chain line, the relationship at the lateral slip angle β (=0.2) is shown by a dotted line, and the relationship at the lateral slip angle β (=0.3) is shown by a broken line.

As illustrated in FIG. 2, at each of the plurality of lateral slip angles β, a lateral grip force of the tire is maximized when the tire does not slip in the longitudinal direction, and the grip force rapidly decreases when the tire starts to slip in the longitudinal direction.

Incidentally, once the braking force of the brake exceeds the grip force of the tire, the tire is locked and slips, which makes it difficult to maintain the running stability of the vehicle. The service brake is provided with an antilock brake system (ABS) capable of controlling the braking force according to the slip rate during the operation of the service brake. The ABS can adjust the braking force so that the slip rate is between 10% and 20%. Thus, the running stability of the vehicle can be maintained. On the other hand, a parking brake in the conventional technique is mainly used to suppress the movement of a parked vehicle. The parking brake includes a parking brake chamber. The parking brake is operated by setting a parking brake chamber pressure to a predetermined pressure, and the operation of the parking brake is released by setting the parking brake chamber pressure to an atmospheric pressure.

The parking brake may be used as a substitute for the service brake when a vehicle is decelerated and stopped. However, the conventional parking brake is not provided with the ABS capable of controlling the braking force according to the slip rate. Thus, the braking force cannot be controlled according to the slip rate during the parking brake application, which makes it difficult to maintain the running stability of the vehicle.

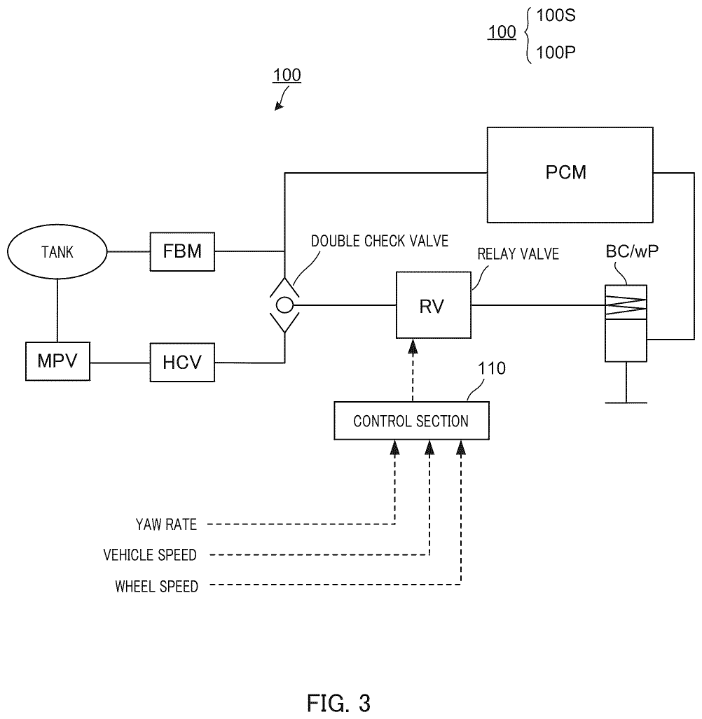

FIG. 3 is a block diagram functionally illustrating an example of a brake system according to the embodiment of the present disclosure. In brake system 100 illustrated in FIG. 3, an air pressure circuit is shown by a solid line, and a signal circuit is shown by a broken line. In addition, control section 110 illustrated in FIG. 3 does not show a configuration in hardware (apparatus) units, but shows a configuration in functional units. Thus, the functional blocks may be implemented in a single apparatus or may be implemented in a plurality of apparatuses. Data transmission and reception among the functional blocks may be performed by any means such as a data bus or a controller area network (CAN bus).

Brake system 100 includes a brake system for each of front wheels and rear wheels. The brake system of the front wheels includes service brake 100S. The brake system of the rear wheels includes service brake 100S and parking brake 100P. In the following, the brake system of the rear wheels will be mainly described, and the description of the brake system of the front wheels will be omitted. In addition, the brake system of the rear wheels may be simply referred to as a brake system and is sometimes represented by “brake system 100.” Furthermore, the rear wheels are sometimes referred to as “wheels.”

Service brake 100S includes a tank, a foot brake modulator (FBM), a pressure control module (PCM), and a plurality of brake chambers with parking brake (BC/wP). The number of brake chambers with parking brake BC/wP corresponds to the number of wheels to which the air pressure of a parking brake circuit is supplied. The plurality of brake chambers with parking brake BC/wP have the same configuration and are brake chambers shared by service brake 100S and parking brake 100P. FIG. 3 illustrates one of the plurality of brake chambers with parking brake BC/wP representatively.

Tank TNK stores compressed air (hereinafter, referred to as air). Foot brake modulator FBM is, for example, a brake pedal that is disposed in the footwell of the driver's seat and operated by the driver. Pressure control module PCM controls the pressure of the air flowing from tank TNK depending on the depression amount of the brake pedal. The pressure-controlled air is supplied to service brake chamber SBC of brake chamber with parking brake BC/wP. This operates service brake 100S. Note that details of brake chamber with parking brake BC/wP will be described later.

Parking brake 100P includes a multi-protection valve (MPV), a hand control valve (HCV), a double check valve, a relay valve, and the plurality of brake chambers with parking brake BC/wP. As described above, the plurality of brake chambers with parking brake BC/wP have the same configuration and are brake chambers shared by service brake 100S and parking brake 100P. In the following description, a chamber of service brake 100S is referred to as a “service brake chamber” and is represented by service brake chamber SBC. A chamber of parking brake 100P is referred to as a “parking brake chamber” and is represented by parking brake chamber PBC.

Multi-protection valve MPV supplies air pressure flowing from tank TNK to hand control valve HCV. Hand control valve HCV is a valve that is disposed next to the driver's seat and controls, by the operation of the driver, a parking brake control air pressure circuit connecting multi-protection valve MPV to the double check valve. The double check valve is a valve having a high-pressure priority function, which supplies, to the relay valve, the higher of the air pressure from foot brake modulator FBM to relay valve RV and the air pressure supplied from hand control valve HCV. Relay valve RV is a valve that amplifies the flow rate of the air. Relay valve RV is a valve that amplifies the flow rate based on a command pressure supplied from the double check valve, supplies the air into brake chamber PBC, and discharges the air from parking brake chamber PBC to the outside. When parking brake 100P is not operated (when traveling or the like), air is supplied to parking brake chamber PBC via relay valve RV, and parking brake chamber PBC is maintained at a high pressure. When parking brake 100P is operated, air is discharged from parking brake chamber PBC to the outside via relay valve RV, and the pressure of parking brake chamber PBC is reduced. Relay valve RV is controlled by control section 110.

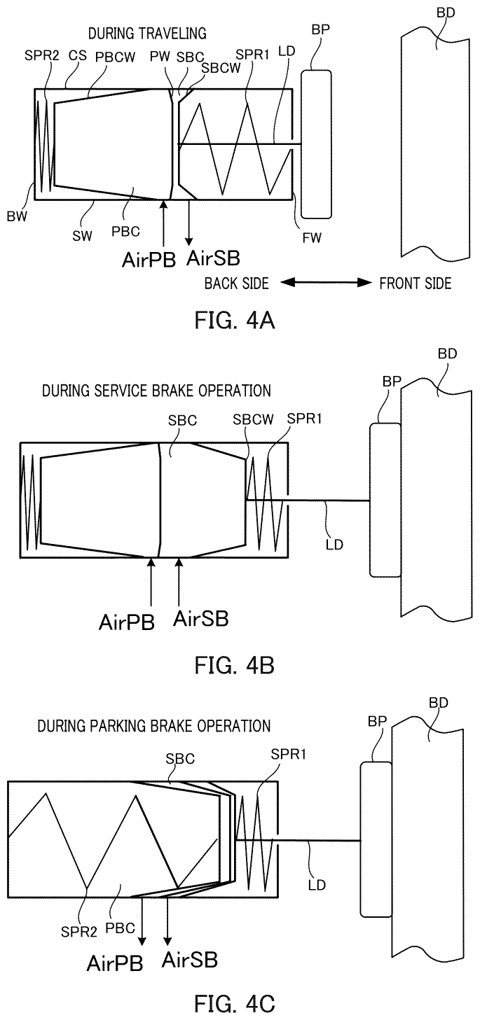

Brake system 100 independently controls the braking force for each of the plurality of wheels. In the following description, the control of the braking force for one wheel will be representatively described. FIG. 4A is a diagram schematically illustrating an example of the brake system during traveling according to the embodiment of the present disclosure. FIG. 4B is a diagram schematically illustrating an example of the brake system during service brake operation according to the embodiment of the present disclosure. FIG. 4C is a diagram schematically illustrating an example of the brake system during parking brake operation according to the embodiment of the present disclosure. FIGS. 4A to 4C each illustrate a brake system of a wheel used for decelerating and stopping the wheel. In FIGS. 4A to 4C, a side closer to brake disc BD of the wheel is referred to as a front side, and a side farther from brake disc BD of the wheel is referred to as a back side.

As illustrated in FIG. 4A, brake system 100 includes case CS, service brake chamber SBC, parking brake chamber PBC, brake pad BP, rod LD, first spring SPR1, and second spring SPR2.

Case CS includes front wall FW located on the front side, back wall BW located on the back side, and surrounding wall SW that encloses the interior from the outside. Service brake chamber SBC is disposed on the front side in case CS. Parking brake chamber PBC is disposed on the back side in case CS.

Case CS and service brake chamber SBC are partitioned by service brake chamber wall SBCW. Case CS and parking brake chamber PBC are partitioned by parking brake chamber wall PBCW. Service brake chamber SBC and parking brake chamber PBC are partitioned by partition wall PW. Air (AirSB) can be supplied and discharged to and from service brake chamber SBC. Air (AirPB) can be supplied and discharged to and from parking brake chamber PBC.

First spring SPR1 is disposed in a compressed state between front wall FW and service brake chamber wall SBCW. Second spring SPR2 is disposed in a compressed state between back wall BW and parking brake chamber wall PBCW.

One end portion of rod LD is connected to service brake chamber wall SBCW. An intermediate portion of rod LD passes through front wall FW and is disposed to be reciprocatingly movable between the front side and the back side of front wall FW. The other end portion of rod LD is connected to brake pad BP.

Pressure control module PCM supplies and discharges air to and from brake chamber with parking brake BC/wP, which is a chamber for a wheel brake, depending on the operation of foot brake modulator FBM.

### (During Release of Service Brake and During Traveling)

Next, the operation of service brake 100S during traveling will be described with reference to FIG. 4A.

During traveling, air is discharged from service brake chamber SBC, and the pressure of service brake chamber SBC is reduced. Thus, service brake chamber wall SBCW retreats from the front side to the back side by a restoring force of first spring SPR1. At the same time, rod LD and brake pad BP are moved from the front side to the back side, so that brake pad BP is spaced from brake disc BD of the wheel. During traveling, parking brake chamber PBC is maintained at a high pressure.

### (During Service Brake Operation)

Next, the service brake operation will be described with reference to FIG. 4B.

Once service brake 100S is operated, air is supplied to service brake chamber SBC so that the pressure of service brake chamber SBC increases. This bulges service brake chamber wall SBCW from the back side to the front side against the restoring force of first spring SPR1. At the same time, rod LD and brake pad BP are moved from the back side to the front side, so that brake pad BP is pressed against brake disc BD of the wheel. This generates a braking force on the wheel. Parking brake chamber PBC is maintained at a high pressure also during the operation of service brake 100S.

The function of antilock brake system ABS is provided, which controls the braking force of the wheel by controlling the pressure of service brake chamber SBC for maintaining the running stability of the vehicle during the operation of service brake 100S. Note that antilock brake system ABS corresponds to a “hardware processor” of the present disclosure. In addition, antilock brake system ABS independently controls the braking force for each of the plurality of wheels.

### (During Parking Brake Operation)

Next, the parking brake operation will be described with reference to FIG. 4C.

In the operation of parking brake 100P, control section 110 controls relay valve RV so that air is discharged from parking brake chamber PBC. This reduces the pressure of parking brake chamber PBC. Note that during the operation of parking brake 100P, the pressure of service brake chamber SBC is reduced. Accordingly, parking brake chamber wall PBCW is displaced from the back side to the front side by the restoring force of second spring SPR2. At the same time, rod LD and brake pad BP are moved from the back side to the front side, so that brake pad BP is pressed against brake disc BD of the wheel. This generates a braking force on the wheel.

The brake system according to the embodiment of the present disclosure includes a feedforward control apparatus that controls a braking force (second braking force) of the wheel by controlling the pressure of parking brake chamber PBC in order to maintain the running stability of the vehicle during the parking brake application. Note that control section 110 illustrated in FIG. 3 includes the feedforward control apparatus. Control section 110 (feedforward control apparatus) corresponds to a “hardware processor” of the present disclosure. In the following description, the feedforward control apparatus may be referred to as an “FF control apparatus.” Furthermore, relay valve RV is controlled so that the FF control apparatus adjusts the braking force of the wheel. The FF control apparatus can control the pressure of parking brake chamber PBC using the feedforward control according to the vehicle speed. The FF control apparatus can further control the pressure of parking brake chamber PBC using the feedforward control according to the wheel speed.

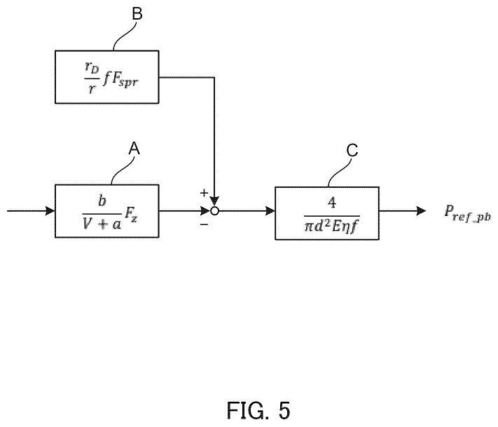

FIG. 5 is a block line diagram illustrating an example of the FF control apparatus according to the embodiment of the present disclosure.

The FF control apparatus includes a storage section and a control section. The storage section is a read only memory (ROM) that stores a program of a computer for implementing the FF control apparatus or a random access memory (RAM) that serves as a workspace of control section 110. In addition, interfaces such as an A-D converter, a D-A converter, an I/O port, and a CAN are provided as interfaces. Note that the ROM may be a storage apparatus, such as a hard disk drive (HDD) or a solid state drive (SSD), which stores an operating system (OS) or an application program and various types of information referred to during execution of the application program.

Control section 110 is a processor, such as a central processing unit (CPU) or a graphics processing unit (GPU), of the FF control apparatus, and functions as follows by executing the program stored in the storage section. The FF control apparatus is not limited to being configured as a single apparatus. The FF control apparatus may be implemented by, for example, a calculation resource such as a plurality of processors or memories. In this case, each unit constituting the FF control apparatus is implemented by executing the program by at least any one of the plurality of different processors.

As illustrated in FIG. 5, the FF control apparatus includes three elements A, B, and C. A transfer function representing the input/output characteristic of element A is represented by Expression 1.

$$\frac{b}{V + a} {F}_{z} \qquad ( Expression 1 )$$

Here, Vis a vehicle speed, a is a road friction coefficient estimation factor, b is a road friction coefficient estimation factor, and F_{z} is an axle load.

A transfer function representing the input/output characteristic of element B is represented by Expression 2.

$$\frac{{r}_{D}}{r} {fF}_{spr} \qquad ( Expression 2 )$$

Here, r is a wheel diameter, r_{D} is an effective radius of the brake disc, f is a brake pad friction coefficient, and Fₛₚᵣ is a spring force of the parking brake.

A transfer function representing the input/output characteristic of element C is represented by Expression 3.

$$\frac{4}{π {d}^{2} E η f} \qquad ( Expression 3 )$$

Here, d is an effective diameter of the brake chamber, E is a brake ratio, and η (eta) is a mechanical efficiency.

Once the vehicle speed V is input to element A, an output signal is output from element A. In addition, an output signal is output from element B. The output signal of element A is subtracted from the output signal of element B. The subtracted numerical value is input to element C. Then, a reference pressure P_{ref_pb} is output as an output signal from element C.

Hand control valve HCV controls relay valve RV so that a parking brake chamber pressure P_{pb} is equal to the reference pressure P_{ref_pb}. The parking brake chamber pressure P_{pb} is detected by a pressure sensor (not illustrated). Hand control valve HCV controls relay valve RV based on the detection result of the pressure sensor.

During the operation of parking brake 100P, air is discharged from parking brake chamber PBC so that the pressure of parking brake chamber PBC reduces, as described above. In addition, air is discharged from service brake chamber SBC so that the pressure of service brake chamber SBC reduces. Accordingly, parking brake chamber wall PBCW is displaced from the back side to the front side by the restoring force of second spring SPR2. At the same time, rod LD and brake pad BP are moved from the back side to the front side, thereby pressing brake pad BP against brake disc BD of the wheel. This generates a braking force on the wheel.

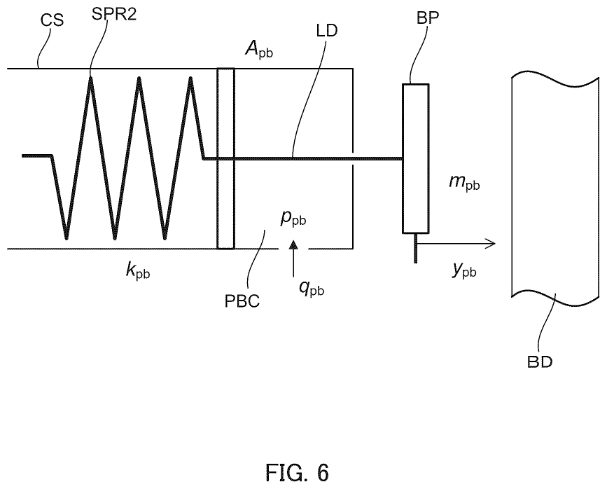

Next, a relationship between the parking brake chamber pressure P_{pb} and a pressing force on the brake disc will be described with reference to FIG. 6. FIG. 6 is a diagram schematically illustrating an example of the brake system of the wheel. In FIG. 6, parking brake chamber PBC and second spring SPR2 in the brake system of the wheel are mainly illustrated and case CS is illustrated as a cylinder. In FIG. 6, service brake chamber SBC and first spring SPR1 are omitted. In the following description, parking brake chamber PBC, second spring SPR2, and the cylinder (case CS) will be mainly described, and the description of service brake chamber SBC and first spring SPR1 will be omitted.

In FIG. 6, A_{pb} is a cylinder cross-sectional area, K_{pb} is a spring constant of second spring SPR2, P_{pb} is a parking brake chamber pressure, q_{pb} is a parking brake chamber flow rate, m_{pb} is a brake pad mass, and y_{pb} is a displacement.

The motion equation of the brake system of the wheel is represented by Expression 4.

$${m}_{pb} {\ddot{y}}_{pb} = - c {\dot{y}}_{pb} - {k}_{pb} ( {y}_{pb} - {y}_{pr} ) - {A}_{pb} {p}_{pb} \qquad ( Expression 4 )$$

Here, m_{pb} is a brake pad mass, y_{pb} is a displacement, C is a damping coefficient (frictional resistance) in a mechanical vibration system, K_{pb} is a spring constant of second spring SPR2, yₚᵣ is an initial deformation of second spring SPR2, A_{pb} is a cylinder cross-sectional area, and P_{pb} is a parking brake chamber pressure.

Next, the state equation of the brake system of the wheel is represented by Expression 5.

$$\frac{d}{dt} [ \begin{matrix}{\dot{y}}_{pb} \\ {y}_{pb}\end{matrix} ] = [ \begin{matrix}\frac{{c}_{pb}}{{m}_{pb}} & \frac{{k}_{pb}}{{m}_{pb}} \\ 1 & 0\end{matrix} ] \vert \begin{matrix}{\dot{y}}_{pb} \\ {y}_{pb}\end{matrix} \vert + [ \begin{matrix}\frac{{k}_{pb}}{{m}_{pb}} & \frac{{A}_{pb}}{{m}_{pb}} \\ 0 & 0\end{matrix} ] [ \begin{matrix}{y}_{pr} \\ {p}_{pb}\end{matrix} ] \qquad ( Expression 5 )$$

Here, y_{pb} is a displacement, c_{pb} is a damping coefficient (frictional resistance) in the mechanical vibration system, m_{pb} is a brake pad mass, K_{pb} is a spring constant of second spring SPR2, A_{pb} is a cylinder cross-sectional area, yₚᵣ is an initial deformation of second spring SPR2, and P_{pb} is a parking brake chamber pressure.

Next, the output equation of the brake system of the wheel is represented by Expression 6.

$$[ \begin{matrix}{y}_{pb} \\ {F}_{cpb}\end{matrix} ] = [ \begin{matrix}1 & 0 \\ 0 & 0\end{matrix} ] [ \begin{matrix}{y}_{pb} \\ {F}_{cpb}\end{matrix} ] + [ \begin{matrix}0 & 0 \\ {k}_{pb} & - {A}_{pb}\end{matrix} ] [ \begin{matrix}{y}_{pr} \\ {p}_{pb}\end{matrix} ] \qquad ( Expression 6 )$$

Here, y_{pb} is a displacement, F_{cpb} is a brake disc application force, y_{pb} is a displacement, K_{pb} is a spring constant of second spring SPR2, A_{pb} is a cylinder cross-sectional area, yₚᵣ is an initial deformation of second spring SPR2, and P_{pb} is a parking brake chamber pressure.

As described above, in the brake system of the wheel, the FF control apparatus (second control section) controls the parking brake chamber pressure according to the vehicle speed. This allows for the adjustment of the brake disc application force due to the biasing force of second spring SPR2. Accordingly, the running stability can be improved by adjusting the brake disc application force during the parking brake application.

Brake system 100 according to the embodiment of the present disclosure is a brake system including: service brake 100S capable of generating the braking force of the wheel on the vehicle; and parking brake 100P capable of generating the braking force of the wheel on the vehicle, and brake system 100 includes: an ABS apparatus that controls the braking force of the wheel according to the vehicle speed of the vehicle; and an FF control apparatus that controls the braking force of the wheel according to the vehicle speed.

With the above-described configuration, the FF control apparatus controls the braking force of the wheel according to the vehicle speed, thereby improving the running stability during the parking brake application.

In addition, in the embodiment of the present disclosure, the brake system further includes parking brake chamber PBC configured to adjust pressure to increase and decrease the braking force of the wheel, and the FF control apparatus controls the parking brake chamber pressure according to the vehicle speed. Accordingly, the braking force of the wheel is increased and decreased by the FF control apparatus controlling the parking brake chamber pressure. Consequently, the running stability during the parking brake application can be improved.

Furthermore, in the embodiment of the present disclosure, air is discharged from the inside of parking brake chamber PBC via relay valve RV. The FF control apparatus controls relay valve RV so that the parking brake chamber pressure is reduced from the high-pressure state. Accordingly, the adjustment of the parking brake chamber pressure is allowed by the FF control apparatus controlling relay valve RV, enabling improvement of the running stability during the parking brake application.

Moreover, in the above-described embodiment, the FF control apparatus controls the parking brake chamber pressure according to the vehicle speed, but in the present disclosure, the FF control apparatus may control the parking brake chamber pressure according to the vehicle speed and the wheel speed. In this case, the wheel speed is measured using, for example, a known wheel speed sensor capable of detecting a rotation speed of the wheel. This allows for further improvement of the running stability during the parking brake application. Furthermore, in the present disclosure, the braking force may be independently controlled for each of the plurality of wheels based on the yaw rate of the vehicle (angular velocity about the vertical axis passing through a center of gravity of the vehicle). This can suppress wheel spins, and thus the running stability of the vehicle can be further improved. The yaw rate of the vehicle need only be detected by a sensor.

In addition, in the above-described embodiment, the FF control apparatus may independently control the braking force for each of the plurality of wheels based on the lateral slip speed of the vehicle. This allows for appropriate control of the braking force of each wheel, which makes it possible to restore from the lateral slip state.

### (Variation)

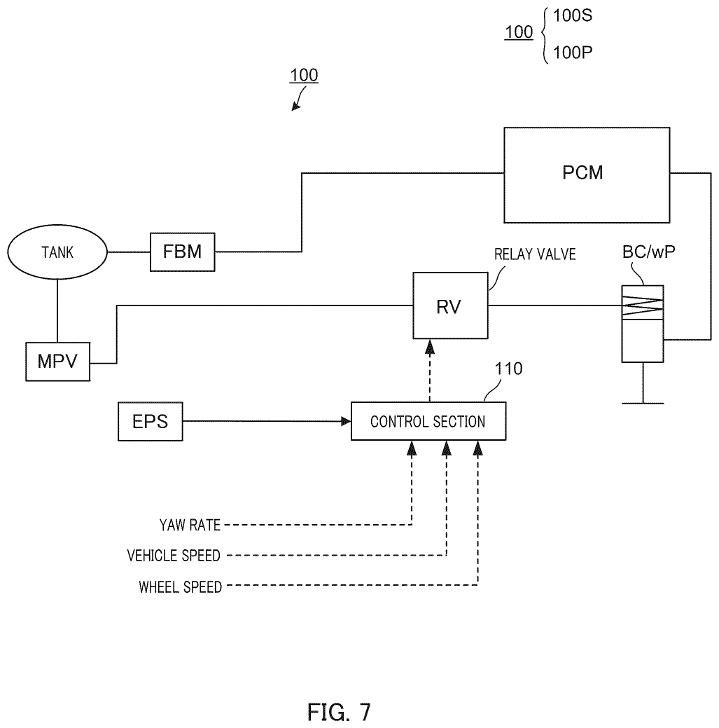

Next, a variation of the brake system in the present embodiment will be described with reference to FIG. 7. FIG. 7 is a block diagram functionally illustrating the variation of the brake system according to the present embodiment. In the description of the variation, a configuration different from the above-described embodiment will be mainly described, and the description of the same configuration will be omitted.

As illustrated in FIG. 3, the brake system in the above-described embodiment includes an air pressure circuit in which the compressed air (air) in tank TNK flows into relay valve RV via multi-protection valve MPV, hand control valve HCV, and the double check valve. On the other hand, the brake system in the variation illustrated in FIG. 7 includes an air pressure circuit in which the air in tank TNK directly flows from multi-protection valve MPV into relay valve RV, and is provided with an electric parking brake switch EPS. Control section 110 recognizes the state of electric parking brake switch EPS and controls relay valve RV based on the recognition result.

The brake system of the variation can improve the running stability during the parking brake application with a simpler configuration than the above-described embodiment.

The above-described embodiment merely illustrates an example of specific implementation of the present disclosure, and the technical scope of the present disclosure should not be construed to be limited thereto. In other words, the present disclosure can be implemented in a variety of ways without departing from the spirit or essential features thereof.

### INDUSTRIAL APPLICABILITY

The present disclosure is suitably used for a vehicle equipped with a brake system that requires improved running stability during parking brake application.

1. A brake system including: a service brake capable of generating a first braking force on a vehicle; and a parking brake capable of generating a second braking force on the vehicle, the brake system comprising a hardware processor that controls the first braking force according to a vehicle speed of the vehicle and controls the second braking force according to the vehicle speed.

2. The brake system according to claim 1, further comprising a parking brake chamber configured to be pressure-adjustable to increase and decrease the second braking force, wherein
the hardware processor controls pressure in the parking brake chamber according to the vehicle speed.

3. The brake system according to claim 1, wherein
the hardware processor further controls the second braking force based on a yaw rate of the vehicle.

4. The brake system according to claim 1, wherein
the hardware processor further controls the second braking force based on a lateral slip speed of the vehicle.
